(19) United States
(12) Patent Application Publication
(10) Pub. No.: US 2011/0219083 A1
(43) Pub. Date: Sep. 8, 2011

(54) EMAIL AUTO-FILING AND MANAGEMENT

(76) Inventor: VICTOR NISHI, Ottawa (CA)

(21) Appl. No.: 12/964,102

(22) Filed: Dec. 9, 2010

Related U.S. Application Data
(60) Provisional application No. 61/310,345, filed on Mar. 4, 2010.

(51) Int. Cl. G06F 15/16

(52) U.S. Cl. 709/206

(57) ABSTRACT

A method, apparatus and computer instructions for automatically capturing, filing and managing email as both individual mail objects and as entire conversation threads. When further integrated with a discussion forum system, the invention makes it possible to share these conversation threads with a discussion forum application so that posts and replies made via the discussion forum application communicate with email users, and email messages can be auto-filed, organized and shared between team members within the forum. And when integrated with an archive system, the invention can automatically file both individual emails and entire threads into an archive system, and can further associated meta-data with these archive objects.

### CROSS-REFERENCE TO RELATED APPLICATIONS

This application claims the benefit of U.S. Provisional Patent Application No. 61/310,345 filed in the USPTO on Mar. 4, 2010.

### FEDERALLY SPONSORED RESEARCH

None.

### BACKGROUND

As its name states, email is an electronic form of traditional mail whereby messages are sent from one person to another, utilizing electronic media as opposed to the traditional pen and paper, envelopes and letter carriers. Like traditional mail, communication is exclusively bilateral: the communication takes the form of a one-to-one exchange of written information between a single sender and a single recipient.

Email is convenient, simple to use and now universally accessible thanks to mobile computing devices. This has helped transform email into the dominant form of electronic written communication in both personal and commercial circles. But its popularity represents a double-edged sword. Along with the obvious benefits of instantaneous and persistent written communication between people, this dominance has also resulted in an ever-increasing volume of email that must be managed.

The bilateral nature of email contributes significantly to its management burden, and this becomes most obvious when communicating with multiple recipients. Email supports communication between multiple recipients by sending copies of the same message from a sender to each recipient. As a result, a single email to 4 recipients generates 5 messages for each reply if you include the message in the sender's “Sent items” folder. If each recipient replies only once, that first email will generate a total of 25 individual messages. For records management purposes, only 5 unique messages need to be filed to capture everything in this thread, but since those messages are received by 5 different people and are distributed across 5 separate email mailboxes, it is possible that all 25 individual messages will be filed. It is, therefore, easy to see how increasing email utilization in team-based business processes has lead to a significant increase in the email management burden.

The widespread use of email and the burden associated with email management has generated a demand for systems aimed at managing email more effectively. These email management solutions take one of three approaches: 1) personal email management; 2) centralized email archiving and storage; or 3) combining email with collaboration devices.

Personal email management solutions help to organize the messages that each individual receives but provide few if any benefits either to other members of a team or to other parts of an organization. They also provide little record or risk management benefits in cases where regulations or litigation demand that email be retained for defined periods of time and/or be reproducible on demand.

Centralized email archiving and storage systems are capable of delivering the records and risk management benefits cited in the paragraph above, but unless people save messages properly by attaching correct metadata as part of the email when filing, the full capabilities of these systems cannot be realized. A simple query to “show me all email related to Project X” can only be run if all messages related to Project X have been filed with a Project Number metadata tag associated to them. While attempts have been made to automate this filing process, no algorithm can reliably infer a project number without assistance from a person with knowledge of the project and some understanding of the context of the message.

In contrast to email systems, discussion forums and related collaboration applications have been purpose-built to associate messages with business process metadata like project number, issue number or other corporate classification systems, but these have failed to come close to the widespread popularity of email for business communication because email is too deeply entrenched as most users' application of choice. While attempts have been made to incorporate email functionality into discussion forum and collaboration applications, these combined systems suffer from the fact that most people are already familiar with their existing email application, and will therefore resist replacing their personal system in favour of one that is designed to support team-centric communication.

All these email management approaches either file email after recipients have received them, or they require users to reject email in favour of the team's collaboration application. In the former case, the number of emails to be filed has not been reduced, and the filing process remains too complex to automate reliably. In the latter case, the team benefits of these new collaboration alternatives are offset by the lost benefits typically associated with personal email. Perhaps more importantly, any switch away from a personal email system requires making changes to an existing way of working that has become habitual, sometimes to the point of obsession.

What is absent from the prior art is truly automated email filing and management system that reduces the total number of messages that email recipients need to file while also improving the quality and accuracy of the filing itself. One that offers individual, team and group benefits without asking email users to leave the familiarity of their current email client or asking companies to rip out and replace the communications infrastructure that they currently use.

### SUMMARY

Example systems and methods facilitate the re-direction, interception or diversion of email content onto centrally managed and communally accessible threads that may then be integrated into a variety of applications where email-enabled discussion threads can be further utilized. In one embodiment, an email (call this the initial email) gets re-directed or diverted away from its normal email server by the email sender's email client application and is saved instead in a central data store. The original email may then be copied or recreated for each intended recipient. However, unlike the original email, each recreated email may include a globally unique identifier (GUID) that associates this email with an email thread. Also in the recreated email, any “Reply to” addresses have been replaced in this embodiment with a single email address associated with the central data store. Thus, all replies to this message will return to a mailbox associated with the central data store for processing, and the presence of the GUM in the reply message may allow the system to associate the incoming email with the same thread as the initial email. By once again sending out a recreated reply email to the intended recipients from the initial message and repeating this process when recipients reply to each recreated reply, each and every reply email whose ancestry can be traced back to the initial email in the thread would get intercepted by the central email mailbox. The content of each of these messages would be automatically saved in the central data store without manual intervention, along with sufficient metadata to reconstruct and present the entire thread according to the parent-child relationship for each message.

### DRAWINGS

The accompanying drawings, which are incorporated in and constitute a part of the specification, illustrate various example systems, methods, and other examples of various aspects of the invention. It will be appreciated that the illustrated element boundaries (e.g., boxes, groups of boxes, or other shapes) in the figures represent one example of the boundaries. One of ordinary skill in the art will appreciate that in some cases one element may be designed as multiple elements, multiple elements may be designed as one element, an element shown as an internal component of another element may be implemented as an external component and vice versa, and so on. Furthermore, some elements may not be drawn to scale.

FIG. 1 illustrates the first embodiment of an email auto-filing and management system, in which the email diversion takes place at the email client, and both the data processing and central data storage are within a remotely located system.

FIG. 1a illustrates the route of a message sent from a single email author to four recipients.

FIG. 1b illustrates the return route of a reply made to the sent message from FIG. 1a.

FIG. 2 illustrates the overall sequence of process steps and functional tasks that make up the first embodiment as shown in FIG. 1.

FIG. 3 illustrates the second embodiment of an email auto-filing and management system, in which auto-filed emails are organized into threads and integrated to a discussion forum application.

FIG. 4 illustrates the third embodiment of an email auto-filing and management system, in which auto-filed emails are centrally filed into an email archive or document management system.

### DETAILED DESCRIPTION

Example systems and methods facilitate: 1) the redirecting, intercepting, relaying, diverting or otherwise sending and receiving of electronic messages including email by a data processing system and the saving of said electronic messages into a central data store as they travel between the message sender and the message recipient; and 2) the organization of these messages into centrally managed threads that may then be integrated into a variety of applications where email-enabled discussion threads can be further utilized.

Directing or re-directing electronic messages including emails into a central data store as they travel between the message sender and the message recipients transforms certain email messages into organized email conversations that can be shared between all email participants and others. The method used to achieve this directing or re-directing further leads to many advantages including providing an opportunity to extract data from the message, apply metadata to it, modify aspects of the message to support the needs of other applications, automate message filing, eliminate duplicate filing, improve email management efficiency, enhance team collaboration and so on. A single redirected email and the modification of that message according to this method makes it possible for example systems to automatically file all reply emails that can trace their ancestry back to that first redirected email.

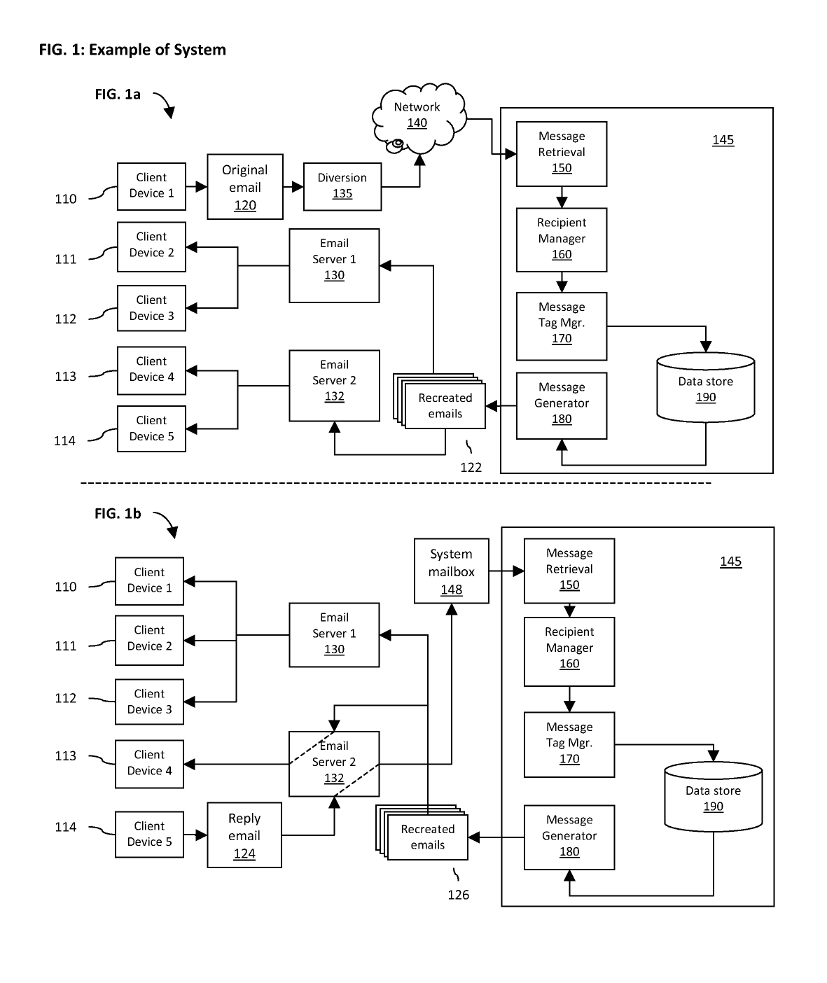

Referring now to the drawings in which like numerals indicate like elements throughout the several figures, FIG 1 is a block diagram illustrating an exemplary environment for implementation of an embodiment of the present invention. While the environment shown in FIG. 1 reflects an embodiment where the electronic message is email, where the email diversion takes place at the email client, and where both the data processing and the central data storage is show within a remotely located system, other embodiments are possible.

FIG. 1 is made up of two similarly arranged system diagrams that trace the processing of an email out to recipients and back from recipients through the first embodiment. Specifically, 1a is a process flow diagram that traces the route of a message from a single email author using Client Device 1 (110) to 4 recipients by way of the first embodiment. FIG. 1b traces the return route taken by a reply made to this original email from client Device 5 (114), again as an illustration of the first embodiment.

Both FIGS. 1a and 1b show a plurality of client devices 110-114. Each client device may be connected to the same or different networks and they may or may not be able to communicate directly with each other via this network. The client devices may be, for example, any combination of computing devices including personal computers, laptops, personal digital assistants (PDAs), terminals or any other computing devices that may be interconnected to other client or server computing devices via a network. These client devises are capable of supporting one or more software applications that can include a word processing application, a spreadsheet application an Internet browser application, an email client application, and other applications capable of being executed by a client device.

Each client device is capable of accessing an email client application either directly installed onto the computing device or accessed remotely via the network. Each email client application is interconnected to an email server 130 or 132. Two email servers are shown in this figure to demonstrate that these computers may or may not be connected to the same email server.

Email servers 130 and 132 may or may not be connected to the same local area network, but they are connected to each other via a wide area network such that they can communicate directly for the purposes of sending email messages.

An email client application associated with at least one of the computing devices 110 is capable of generating a newly composed original email 120. The email client application may be further configured to send this email to an email server 130 for further processing, as it would do for any normal email. It may also be configured to engage an alternate external application such as an Add-in or Plug-in, or apply alternate software commands included in the email client application software to cause the diversion, interception or re-direction 135 of this original email 120 via some network 140 to connect with an alternate system of data processors and storage devices 145. The redirected email data are transferred using an information exchange protocol. The information exchange protocol can comprise, for example, any suitable rule or convention facilitating data exchange, and can include for example any one of the following communication mechanisms: Extensible Mark-up Language—Remote procedure Calling protocol (XML/RPC), Hypertext Transfer Protocol (HTTP), Simple Object Access Protocol (SOAP), shared memory, sockets, local or remote procedure calling or any other suitable information exchange mechanism.

Diverting the original email 120 away from the email server 130 and to system 145 may be initiated in many ways. So while this example may describe a diversion triggered manually by the email composer after the email has been composed by way of a plug-in or add-in that can be added to any email client application, it is to be appreciated that in some examples this diversion may be manually triggered by the email composer at any stage during the email composition or email sending process by way of any one of a number of methods. Such methods may include by way of a direct modification to the email client application's software code, by way of an add-in or plug-in application installed to and configured as part of their email client, or by way of a separate software application running on or accessible from their computing device 110. This diversion processor 135 could divert, redirect or intercept the message at any stage during email composition or sending including when composing the message, prior to sending the message, after sending the message or at any other time during email composition and sending. It could also be triggered automatically by the email client application 110, by the email server 130 or by some software application operating on another computing devise that is capable of intercepting messages travelling to or from the email server 130.

At the time when the diversion is triggered, the email sender may be asked to define a location where they want this email to be saved and/or any other metadata that might be usefully associated with this email. Additional metadata may also be applied to or associated with the email message automatically by some diverting application or processing code. These metadata may include information such as project number, team name, issue number, keyword, client name, department number, bug number, tracking number, part number or any other metadata tag that might logically be associated with this message and the things that relate to this message, and may help to locate this message via a database search query.

System 145 may comprise a set of data processing systems, network infrastructure and storage devices capable of executing software code and storing data. One or more of these data processing systems executes a computer usable program code that includes code for message retrieval 150, recipient management 160, message tag management 170, and message generation 180. The computing devices making up System 145 would also include a data store 190. In one example, the data store 190 may be a database. And while in this example we describe a database configured to store data that are retrieved from an incoming email message, and parsed and manipulated to facilitate the management of that message for a set of particular purposes, it is to be appreciated that the database may also be further configured to store data of various types for various purposes that may or may not be directly or indirectly related to these messages.

While system 145 is described in this example as comprising and being contained within a single system, it is to be appreciated that the business logic and associated tasks may be distributed across multiple related or unrelated systems. And while the system described in this example consists of a data store 190 and four sub systems corresponding to 4 business logics (e.g. 150, 160, 170, and 180), it is to be appreciated that in some examples the tasks performed by these four business logics may be combined into a lesser number of related logics or distributed between an even greater number of logics supporting other processes that may or may not be part of the same computer application, and may or may not be operating within the same computing devices.

The message retrieval processor 150 can be configured to capture, parse and process the data transferred to it by the diversion mechanism 135, and to eventually store that data into data store 190 configured to accept these data. This message retrieval processor 150 may directly receive and process the incoming data or it may temporarily store these data for processing at some later time. This retrieval processor 150 could parse the incoming message, drawing from it some or all of its component parts that may include the email header, the email body, the email attachments along with any other message data and/or any additional metadata that may have been associated with this message data prior to or during transmission. Once parsed, some or all of these data could be stored in the data store 190.

System 145 may also include a message tag manager 170 capable of generating, managing, distributing, collecting and analysing globally unique identifiers (GUID) for each processed message. Among other things, each GUID would associate each message with a thread that contains all emails that can be traced back to the original email 120 and would further include sufficient information to reconstruct the parent-child relationship between each message in the thread. Among other things, the message tag manager 170 would be capable of generating new GUIDs for messages, saving GUIDs to the data store 190 and for managing all aspects of the logic necessary to maintain and utilize these GUIDs.

While this example describes the use of a message tag made up of a set of clear-text or encrypted characters corresponding to the GUID, and that the purpose of the GUID is to associate this message and any replies to this message to the thread created by the original email 120, it is to be appreciated that this GUID can take other forms, contain other information and be used for other purposes in other examples.

At some point during or after the data from the original email has been retrieved, parsed and stored in data store 190, the intended recipients for the original email may be defined and saved in the data store by the recipient manager 160 as the recipient list for not only this email, but for all future emails belonging to or otherwise associated with this thread as defined in the data store 190.

Having retrieved, processed and saved the information from the original email 120, system 145 may now engage a message generator 180 capable of generating one or more recreated emails 122 using data retrieved from data store 190. In this embodiment, each recreated email 122 could contain much if not all the information contained in or associated with the original email 120, along with any additional information that might be added to it depending on the needs of system 145 and/or applications or uses associated with it in other embodiments. The recipients for these recreated emails could include the intended recipients for the original email 120, and/or any other recipients, but unlike the original email 120, each recreated email 122 would contain a reply email address that points to a system mailbox (148 in FIG. 1b) that is associated in some way with system 145 and accessible to the message retrieval processor 150.

Message generator 180 could also be configured to insert somewhere in each recreated email 122 an encrypted or clear-text set of characters representing the CHAD for this message so that when a reply email gets captured and processed by system 145, it can be associated with the other emails in that same thread. And since it is characteristic of most email client applications to include sonic information from the incoming message when creating a reply to that message, message generator 180 would insert these characters into one or more of the parts of each recreated email 122 that are most likely to be included in the reply. Example locations include but would not be limited to portions of the incoming email's header, some variant of the incoming email's subject line, or portions of the body of the incoming email,

Message generator 180 could then send each recreated email 122 to the email servers 130 or 132 associated with each email recipient (111 through 114). It could send these mails directly or via any intermediate email server and could be transmitted using any typical email transfer protocol that may include Internet Message Access Protocol (IMAP) and/or Simple Mail Transport Protocol (SMTP). By the end of the process flow outlined in FIG. 1a for this embodiment, some version of the contents of the original email 120 has reached all intended recipients by way of system 145.

Referring now specifically to FIG. 1b, a user associated with Client Device 5 (114) composes and sends a reply email 124. This message is in response to the recreated email 122 that this user received in FIG. 1a.

In this embodiment, Client Device 5 (114) may have installed on it any email client application capable of receiving, composing and sending email. It may or may not have installed onto it, have integrated to it, or be associated with any diversion processor equivalent to the diversion processor 135 listed in FIG. 1a because in this embodiment there is no requirement for such a device to divert the email if it is a reply to an originally diverted email. Since all email client applications are programmed to send reply messages back to the email addresses identified as “From” “CC” or “Reply to” recipients in the header of the incoming email message, the inclusion of the address for system mailbox 148 as a reply recipient in the email header of the recreated email 122 ensures that any reply email 124 will be sent to the system mailbox 148 for processing.

System mailbox 148 may be configured so that it is accessible to either the same message retrieval processor 150 described in FIG. 1a, or by a different message retrieval processor that operates in much the same way as processor 150. Entails sent to this system mailbox 148 could therefore be retrieved and processed in a manner similar to that applied to the original email 120. The email message content and associated metadata from reply 124 could be extracted and parsed, including the GUID that identifies the reply message as a child of the original email 120. This reply message could be saved in data store 190 as being part of the same thread started by the original email 120, and a set of recreated reply emails 126 could be generated by the message generator 180. Since the reply came from Email Client 5 (114) and was sent to the system mailbox 148, the message generator 180 cannot look to the reply email 124 to determine the email addresses for the intended recipients. But message generator 180 can query data store 190 for the list of intended recipients associated with the original email 120, and use their email addresses as the recipients for each of the recreated replies 126.

Before sending out each recreated reply 126, the message tag creator 170 may create a new GUID for this second round of replies such that replies to recreated reply 126 could be accurately associated to the thread that was initiated by the original email 120, and further designated as a child of the recreated reply 126.

One of ordinary skill in the art will appreciate that by triggering or engaging a diversion or interception processor or agent in the manner described in FIG. 1a, and then by repeating these same processing and storage steps described in FIG. 1b for each reply email as it is received in system mailbox 148, every email whose ancestry can be traced back to the original email 120 could be automatically captured and processed by the system 145. And depending on the specific data saved in data store 190 and the information included in each GUID, each message in the entire thread could be organized, arranged and/or presented according to its parent-child relationship to other messages in the thread.

Thus a single email saved and diverted into system 145 in some variation of the manner described in this example may allow for automatically filing a single copy of each reply without duplication, and for further organizing these replies into logical threads that clearly demonstrate the contextual relationship of each message to all other messages in the thread.

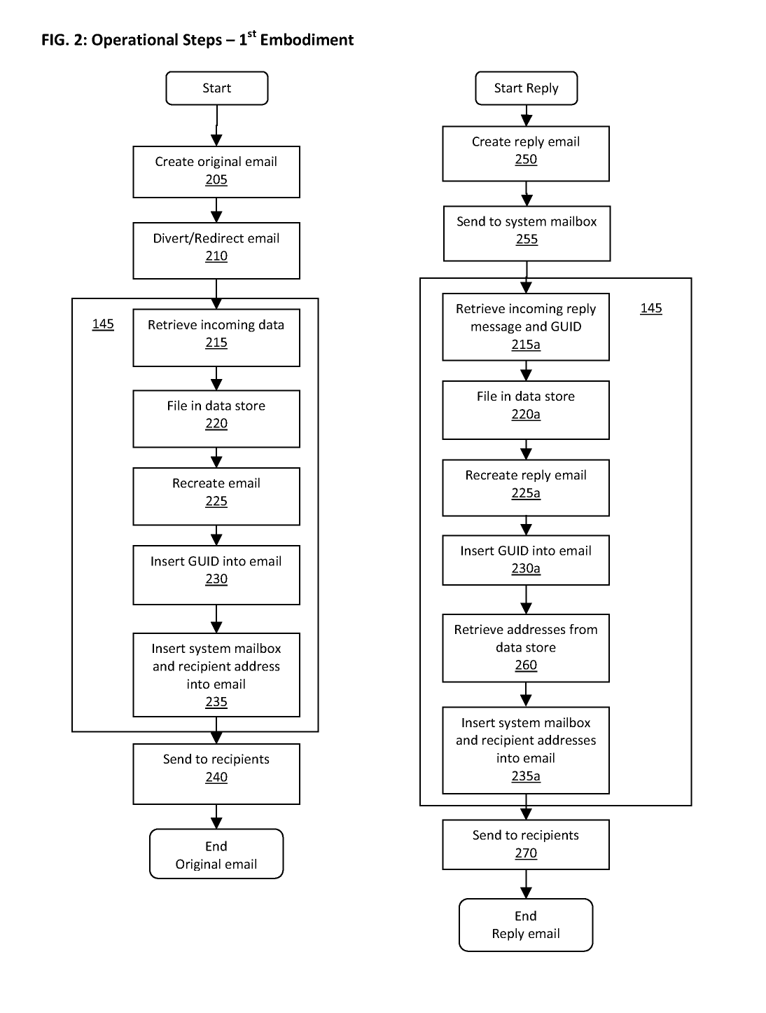

For greater clarity, FIG. 2 illustrates the operational steps described in the first embodiment, presented here as a simplified flow diagram that includes only the sequence of process steps and functional tasks. By eliminating the need to represent systems, computers, networks and the physical relationships between them, we can simplify the figures and more clearly communicate the logic of the functional processes that underlie each embodiment.

Just as in FIG. 1, embodiment 1 starts with the creation of an original email 205. That email may be redirected by some diversion process 210 to some retrieval process 215 that is capable of retrieving, parsing and manipulating the incoming data before a storage process 220 saves the data into a data store. The data from the data store may then be used in process step 225 to recreate a set of emails that may include some or all of the content of the original email and may also include some or all of the intended recipients of the original email. Another process 230 may be responsible for inserting into each email a globally unique identifier capable of connecting this message to the original email created in process step 205. A final process step 235 may define the reply email address for each of these recreated emails as the address to a system mailbox that is associated with the data store. These messages may now be sent as step 240 via normal email transmission to recipients including the intended recipients of the original email.

One of ordinary skill in the art will appreciate that all of the processes 220 through to 235 in FIG. 2 may be carried out by the processors, software applications and computing devices described as part of system 145 in FIG. 1a.

Any user who receives a copy of the recreated email sent via process 240 may choose to reply by creating and sending a reply email prepared by process 250. Unless the user manually changes the reply address for this reply email, it will be sent to the mailbox associated with the data store as indicated in process 255. The contents of the reply email, including the sender's email address, date and time when the message was sent, the GUID and other information may be retrieved by process 215a. Process 220a would save these data into the data store. Using the information contained in the GUM, process 220a may further associate this data from the reply email with the thread initiated by the original email from process 205, and save this additional information in the data store.

Process 225a may then recreate the reply email, including in it some or all of the contents of the original reply email. Process 230a may then generate and insert into each recreated email a new GUID that identifies this recreated reply as the child of the parent email created at process 225 and belonging to the thread initiated by the email created in process 205,

Since the reply email from process 250 may not have contained any recipient email addresses except for the mailbox associated with system 145, process 260 could be capable of retrieving the email addresses for the recipients associated with the thread initiated by the original email, and insert these addresses into each recreated email as part of process 235a. Process 235a could also insert the email address for the mailbox associated with system 145 before passing the message to process 270 for delivery to all intended recipients.

One of ordinary skill in the art will appreciate that process steps 215a, 220a 225a, 230a and 235a may be handled either by the same or by a variation of computing devices and associated computer software that handled process steps 215, 220, 225, 230 and 235 respectively. One of ordinary skill in the art will also appreciate that all of the processes shown as contained with system 145 in FIG. 2 may be carried out by the processors, software applications and computing devices describes as part of system 145 in FIG. 1b.

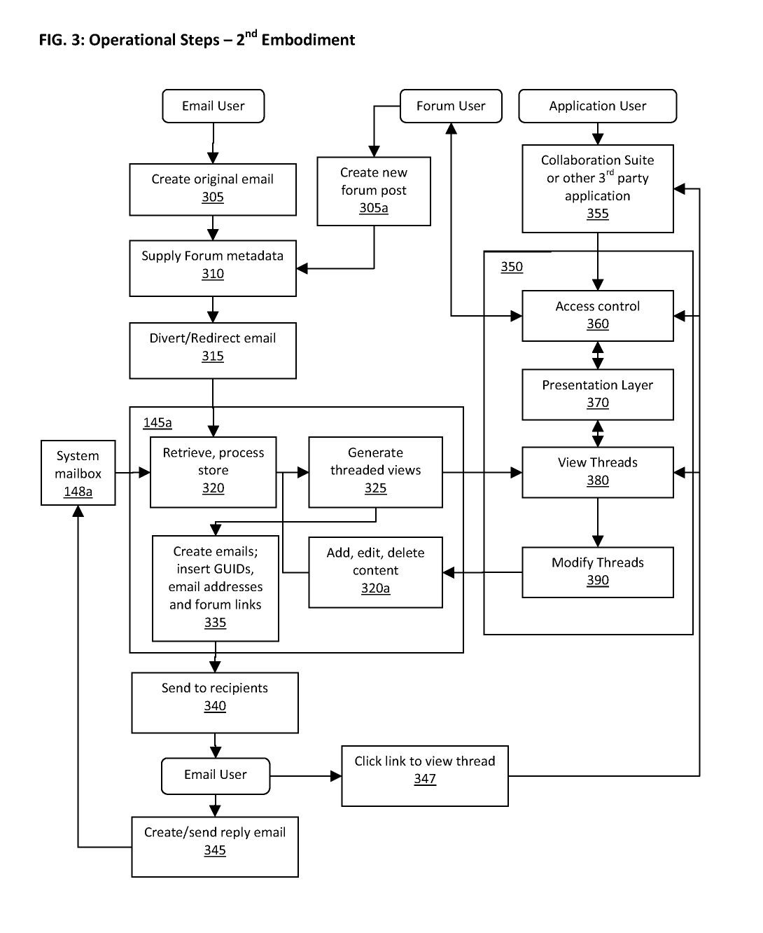

FIG. 3 illustrates a second embodiment where emails are diverted, auto-filed and organized into threads that may then be integrated to a discussion forum application and/or to one of many other third-party applications that might incorporate discussion forum functionality into their application code or their business processes. This figure is a process flow diagram similar to that described as FIG. 2. System 145a and system mailbox 148a are variations on system 145 and system mailbox 148 respectively, as described in FIG. 1 and/or FIG. 2.

Starting again with a user creating an original email as part of process 305, the user may be offered the option to select a folder or location to file this email thread as part of the additional metadata collected in process 310. This selection may trigger process 315 to divert or re-direct the email away from an email server and transmit it instead to system 145a. As with the first embodiment, the redirection at process 310 in this embodiment may be automatic or manual and the user may further be asked to provide additional metadata at the time of diversion.

In this embodiment, system 145a may be connected to or integrated with a particular forum system 350.

Forum system 350 may be any variant of a type of team communication or collaboration software application used to post messages that are related to a given subject matter or to a given group of users. Forums may also be referred to using other names including boards, discussion boards, discussion forums or on-line forums.

While forum system 350 is described in this example as comprising four functional elements: an access control mechanism 360, a presentation layer 370, a message or content viewing mechanism 380 and a content editing mechanism 390, it is to be appreciated that in some examples the forum may include greater or fewer functional elements organized in different configurations. Similarly, forum 350 is described in this example as a stand-alone forum application, but it should again be appreciated that the forum may be further integrated into a suite of collaboration tools that may include shared document management, instant messaging, video conferencing, blogs, wikis and so on. The forum may also be integrated as part of any other application such as a word processor, spreadsheet application, presentation application, workflow application, or any other application where groups of users may wish to engage in an on-line discussion relating to the contents or the business processes supported or managed by that other application. The processing steps associated with these collaboration applications or other third party applications are shown collectively in FIG. 3 as process 355.

In one example of the integration between system 145a and forum 350, both systems may share the same message data for some or all email threads that system 145a manages. The forum system 350 may include process 380 that is configured to query the data store for system 145a and return all messages associated with a particular thread. Process 380 could then sort the emails in the thread in any number of ways including by subject, by sender, by the time received or by thread, and serve this up to forum users within the forum's presentation layer 370 (after first navigating through the forum's access control 360). In this way, this second embodiment makes the threaded email content indistinguishable from typical forum content.

Also within this embodiment, the forum user may further wish to modify the thread, perhaps by replying to the thread using the forum's own functionality 390. In this case, by configuring the forum to communicate with a content editing process 320a within system 145a instead of with the forum's own data store, these forum manipulations may be observed within the forum as if the manipulations had taken place within the forum's own data stores.

This content editing process 320a may be configured within system 145a either as part of, or a variation of, the existing process 320 used to process incoming emails. As a result, a person having ordinary knowledge of the art would appreciate that any message or reply posted to the thread via the forum 350 illustrated in this embodiment could be configured to look and act the same as any email reply that finds its way into system mailbox 148a. The forum post would be inserted and sorted within the thread just like any incoming reply email, and would be sent out to some or all recipients via email as if the reply had been initiated by a reply email sent to the system mailbox 148a. Similarly, any email that is diverted or intercepted and stored as part of a thread via system 145a and process 320 in this embodiment would appear indistinguishable from any content posted from within forum system 350.

FIG. 3 further shows how this second embodiment may also include process 335. This process may include and/or be a variation of the collection of processes responsible for preparing the recreated emails, specifically processes 225a, 230a, 260 and 235a in FIG. 2. In this embodiment, however, process 335 may differ from the collection of processes described in FIG. 2 in that it may also be capable of inserting one or more hypertext links into each email that point to a view of the entire thread containing this email. Instead of replying to an email, an email recipient may choose to click on the hypertext link (process 347) to view (perhaps in a browser window) some variation of the same thread delivered by process 380.

In the same way that the forum software is capable of displaying the emails in this thread on a page via process 380, and sorting the messages on this page according to multiple criteria including subject, author, time received, thread and so on, the link in the email can be programmed to serve up the same or a similar page in a browser window (either via process 380 or via, a variation of process 380), thereby showing this email message within the context of the entire thread. The link in the email could he further configured to serve up the contents of the thread within one of many alternate presentation layers including the forum application itself (via access control 360 and presentation layer 370), or via a further integration to a third party application (by way of process 355) responsible for managing other content or data that may the subject of an email discussion.

Thus, an example email in this second embodiment may be directed or diverted and ultimately saved to a team folder that team members can view within a discussion forum or alternatively within a third part collaboration suite that includes a discussion forum. Discussion forum users could reply to this original email via either the discussion forum interface or via a reply email. In either case, emails may be programmed to go out to all recipients of the original email. And every email in the thread may contain a hypertext link to a page that includes all replies in the thread (email or posted) organized according to their parent-child relationship.

One of ordinary skill in the art will appreciate that a new thread could similarly be initiated by a forum user instead of by an email user, whereby a new post to the forum 305a acts as the original email created in process 305. In this example, process steps 310, 315 and 320 are shown as processing both original entails 305 and new posts 305a, but other configurations are possible including replicating these processes within discussion forum 350 and accepting the new post via process 320a instead of by process 320. Regardless of where these processes reside, the resultant thread could be made to appear indistinguishable from an email-initiated thread via the threaded view generated by process 325. Email recipients could be defined by the forum user as part of the metadata supplied in process 310, thereby permitting the creation of recreated emails in process 335 and their distribution to recipients in process 340.

Thus, a new forum post made via this second embodiment could initiate an electronic conversation that takes place via both email and discussion forum posts. Email recipients may be defined as if the conversation thread began via email, and these recipients can once again choose to reply via email or via discussion forum at their discretion. Regardless of the response option selected, each reply will be automatically filed, organized and circulated according to the same process steps.

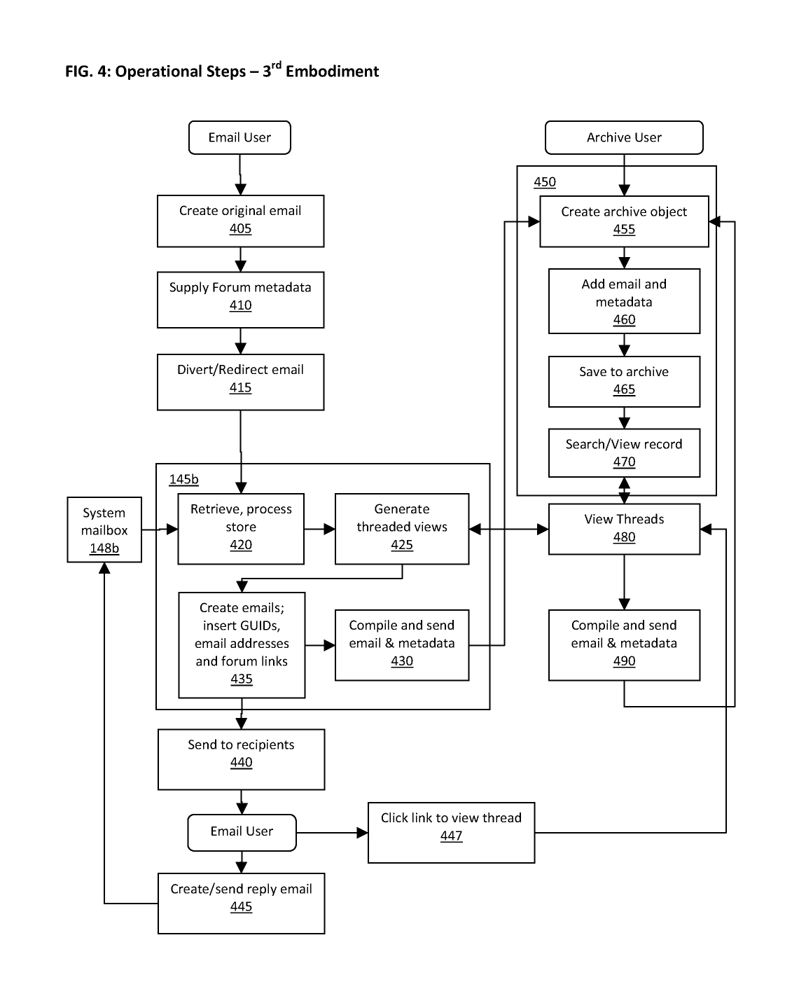

FIG. 4 illustrates a third embodiment where emails are diverted and centrally filed into an email archive or document management system. This figure is a process flow diagram similar to that described in FIG. 2 and in FIG. 3. System 145b and system mailbox 148b are variations on system 145a and system mailbox 148a respectively as described in FIG. 3, and the processes within system 145b, including processes 420, 425 and 435, are similar in functions and in purpose to processes 320, 325 and 335 in FIG. 3.

Starting once again with a user creating an original email as part of process 405, the user may be offered (as part of process 410) the option to select a folder or location to file this email thread. This selection may trigger process 415 to divert or re-direct the email away from an email server and transmit it instead to system 145b, As with the first and second embodiments, the redirection at process 410 in this embodiment may be automatic or manual and the user may further be asked to provide additional metadata at the time of diversion.

In this embodiment, system 145b may be connected to or integrated with a particular archive system 450.

The archive system 450 may take several forms including a simple file server organized according to some organizational structure designed or intended to facilitate later retrieval, a records management or archiving application that supports document and email retrieval as well as enforcing records management requirements for file retention and disposal, a centralized document management system that manages document assembly, version control, editing control and enhanced document retrieval, or any other electronic file or content management system capable of accepting email content in one form or another.

For illustrative purposes, archive system 450 includes a simplified depiction of those elements involved in creating a new archived object or viewing an existing archived object. This may include a process 455 to initiate the creation of a new archive object and a data profile associated with that object, a process 460 to attach a copy of an electronic file to the object and add metadata to the object's data profile, a process 465 to save that object into some data store and a process 470 to view that object and its associated profile data. While in this example we include 4 functional elements, it is to be appreciated that in some examples the system may include greater or fewer functional elements organized in different configurations.

In one example of the integration between system 145b and archive system 450, a data compilation process 430 may be triggered whenever one or more emails are recreated as part of process 435. Process 435 could be configured to pass an additional copy of the recreated email to process 430 for archiving to system 450. More specifically, process 430 may be configured to communicate with a process 455 located either within or associated with archive system 450. Process 455 would be responsible for accepting the email file from process 430 and creating a new archive object and/or record within archive system 450. Communication between process 430 and process 455 may be by way of some network connection using some standard communications protocol and possibly utilize some customizable application programming interface (API) that may exist as part of the archive system 450 to facilitate the integration of third-party computer applications to archive system 450. Ultimately, process 430 would be capable of supplying process 455 with whatever information including copies of the email files, email attachments, email sender, email recipients, email time, email date or any other information or metadata that archive system 450 and process 455 needs to create and save the new archived object or record.

Process 430 may also compile from the database within system 145b any additional metadata associated with this email and pass this to the archiving application. The archiving application may then use these additional metadata to manage the archived object more effectively or to save and retrieve the archived object more accurately. Additional metadata could include any information found in the database for system 145b. For example, the sender of the original email may have chosen to file it within a folder structure that is based on project numbers. If each project number were further associated with additional metadata such as project name, project director, client number, department code, project key-word and so on, any or all of these associated data parameters may be compiled and associated with the email as part of process 430 and further passed on to process 455 for inclusion as part of the archive object and its associated object profile. In this way, a great deal of important and detailed metadata may be associated with a particular archived email simply by virtue of the fact that it was filed in a particular folder that was associated with a particular project number in system 145b.

Process 455 may be configured to receive the communication from process 430. Depending on the requirements of the archiving system, process 455 will request (and/or process 430 will supply) whatever information is required to create a new archived object. The archived object may be associated with a data-sheet, a profile, a record or other collection of related data fields that organizes all metadata that the archived system may use to manage the archived object more effectively, or to save and retrieve the archived object more accurately. Process 460 may then insert the metadata into the archived object's profile and save this along with a copy of the email into the archive system's data store via process 465.

Once saved, process 470 may allow archive users to search for archived objects using metadata parameters included in each object's profile when saved, and to view each archived object via some computing device. These metadata parameters are available in many of today's email archive systems, but users are reluctant to take the time necessary to attach accurate and appropriate metadata when filing. Thus an example integration between system 145b and archive system 450 would not only automatically every email to the archive system on behalf of each email recipient, but also associate with each automatically filed email additional metadata to make that email easier to find in any future database search.

Through a further integration to system 145b, the archive system may be configured to view the entire thread that contains the archived email via a process 480 that may reside within the archive system, may reside back in system 145b as part of process 425 or may reside somewhere between the two systems as shown in FIG. 4. Metadata saved in either or both systems could be used by this integration to connect an email in archive system 450 to its parent thread in system 145b, viewed through process 480. Similarly, a thread in system 145b could include links to view copies of each constituent email stored within archive system 450, and to further toggle back and forth between a threaded view of a collection of entails and a copy of each individual email within the archive system.

As in embodiments one and two described earlier in this document, the email created in process step 405 will eventually trigger the delivery of emails to a set of intended recipients in process 440. Replies to these emails will be delivered to system mailbox 148b, retrieved by process 420 and stored into the data store for system 145b. In each case, process 435 will trigger process 430 to compile the appropriate metadata and save a copy of the reply email in archive system 450. Since each reply to the original email created in process step 405 is likely to be in some way related to the subject matter referred to in that email, it stands to reason that the metadata associated with that email would apply at some level to each reply in the thread. Process 430 may therefore be programmed to associate some or all of the same metadata to each reply email when saving the email to the archive system 450.

Thus, any original email diverted or re-directed to system 145b when integrated to an archive system 450 as explained in embodiment 3 may be automatically filed as an archived object in archive system 450 along with any metadata that might be associated with that original email in the database for system 145b. Furthermore, any reply email that can be traced back to an original email archived via embodiment 3 may similar be automatically saved along with additional metadata deemed to be common to the thread and thus appropriate for all its replies. All these messages may be viewed within organized threads within system 145b or viewed individually with archive system 450.

FIG. 4 also shows an example where process 490 may be configured to archive each entire thread as a single archived object in archive system 450. In a manner similar to process 430, process 490 might compile metadata from the data store in system 145b and use it to initiate the creation of an archived object via process 455. Additional metadata about the thread could be further retrieved from the data store in system 145b and saved as the thread's metadata process 460 and some copy or snapshot of the entire thread could be saved to the archive system's data store in process 465. Since each thread may be a dynamically created set of emails arranged in a threaded view based on a database query, the archived thread may have to be converted into a format that is permanent and unchanging. In this example we envision that the archived thread could take the form of an image file in some standard image format such as .jpg, .gif, .pdf, but other electronic formats and electronic capture techniques are possible to achieve a permanent and file-ready object.

It is important to note that while the present invention has been described in the context of a fully functioning data processing system, those of ordinary skill in the art will appreciate that the processes of the present invention are capable of being distributed in the form of a computer readable medium of instructions and a variety of forms, and that the present invention applies equally regardless of the particular type of signal bearing media actually used to carry out the distribution. Examples of computer readable media include recordable-type media such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modification and variations will be apparent to those of ordinary skill in the art. The embodiments were chosen and described in order to best explain the principles of the invention, the practical applications, and to enable others of ordinary skill in the art to understand the invention for various embodiments with various modifications as are suited to the particular use contemplated.

What is claimed is:

1. A method in a data processing system for managing electronic messages whereby:
a. all messages are organized as discussion threads; and
b. the central object for management and organization purposes is the thread rather than the individual messages.

2. A method in a data processing system for managing electronic messages, the method comprising:
a. receiving an initial electronic message by said data processing system;
b. modifying said initial electronic message to create one or more recreated messages;
c. defining that said data processing system he a recipient of a reply message made in response to said recreated message(s); and
d. upon receipt of said reply message, associating said reply message with said initial electronic message,
whereby said reply messages are received by said data processing system without the addition of any manual effort on the part of message recipients beyond simply replying to said recreated messages,

3. The method of claim 2, further comprising:
a. modifying said reply message by said data processing system to create one or more recreated reply messages; and
b. defining that said data processing system he a recipient of a second reply message made in response to said recreated reply message(s),
whereby any reply message that can be traced back to said initial electronic message in a parent-child relationship may be similarly received by said data processing system without the addition of any manual effort on the part of the message recipients beyond simply replying to said recreated reply messages.

4. The method of claim 2, further comprising parsing the contents of said initial electronic message and storing the parsed message contents into a data storage device.

5. The method of claim 2, wherein said electronic messages include emails.

6. The method of claim 5, wherein an email address is used to define said data processing system as a recipient of said reply message.

7. The method of claim 2 wherein an email client application sends said initial electronic message to said data processing system.

8. The method of claim 2, wherein a globally unique identifier is used to associate said reply messages to said initial electronic message.

9. The method of claim 8, wherein said globally unique identifier is used to organize said initial electronic message and said associated replies into conversation threads.

10. The method of claim 2, further comprising a means for diverting email from an email server and sending it instead to said data processing system.

11. The method of claim 2, further comprising a means for associating additional metadata with said initial electronic message.

12. The method of claim 2, wherein the method is implemented as part of an archiving or document management system.

13. The method of claim 12, further comprising a means for automatically filing electronic messages into said archiving or document management system.

14. The method of claim 2, wherein the method is implemented as part of a discussion forum and said electronic messages further include forum posts, email notifications or RSS feeds.

15. The method of claim 14 wherein the method is implemented as part of said discussion forum and further included as part of a wiki or blog software program.

16. The method of claim 2, wherein the method is implemented as part of a chat or short messaging system (SMS) and said electronic messages further include chat or SMS posts.

17. A data processing system for managing electronic messages, the data processing system comprising:
a. a bus system;
b. a memory connected to the bus system, wherein the memory includes computer useable program code; and
c. a processing unit connected to the bus system, wherein the processing unit executes the computer useable program code to:
d. receive an initial electronic message and parse its contents into a data storage device;
e. modify said initial electronic message by said data processing system to create one or more recreated messages;
f. define said data processing system as a recipient of a reply message made in response to said recreated message(s); and
g. upon receipt of said reply message, associate said reply message with said initial electronic message.

18. The data processing system of claim 17, wherein said data processing unit further executes the said computer useable program code to:
a. modify said reply message by said data processing system to create one or more recreated reply messages; and
b. define that said data processing system be a recipient of a reply message made in response to said recreated reply message(s).
